(19) United States
(12) Patent Application Publication
(10) Pub. No.: US 2024/0394840 A1
(43) Pub. Date: Nov. 28, 2024

(54) System And Method For Generating Digital Content Including Portions Of Captured Images

(71) Applicant: Google LLC, Mountain View, CA (US)

(72) Inventors: Elchonon Zeav Lapin, Scottsdale, AZ (US); Xibing Yang, Fremont, CA (US); Amit Handa, Milpitas, CA (US); Apurv Suman, New York, NY (US); Siddhant Mittal, New York, NY (US); Ashish Dilipchand Bora, Sunnyvale, CA (US); Thorne Wolfenbarger, Santa Clara, CA (US); Naga Sreenivas Meruva, San Jose, CA (US); Yudong Sun, Cupertino, CA (US); Rahul Guin, San Jose, CA (US); Arie Sharon, Hoboken, NJ (US); Beatriz Alessio Robles Orozco, San Francisco, CA (US); Yuanzhen Li, Newton, MA (US); Zhongyue Zheng, Millbrae, CA (US); Mohammad Izadi, San Jose, CA (US)

(21) Appl. No.: 18/669,939

(22) Filed: May 21, 2024

Related U.S. Application Data
(60) Provisional application No. 63/468,132, filed on May 22, 2023.

(51) Int. Cl. G06T 5/50; G06T 3/40; G06T 5/70; G06T 7/13; G06T 7/194; G06T 7/50; H04N 5/272

(52) U.S. Cl. CPC G06T 5/50; G06T 3/40; G06T 5/70; G06T 7/13; G06T 7/194; G06T 7/50; H04N 5/272; G06T 2207/20221; G06T 2207/20224

(57) ABSTRACT

Using artificial intelligence (AI), imagery may be created for content in response to verbal or textual input. The imagery includes an object, such as a product, and a quality of the image is improved using pre-processing techniques before the image is generated and post-processing techniques after the image is generated. The pre-processing may include upscaling the object in the original image, segmenting the object from its background in the captured image, adding an outline or border stroke to the object. The post-processing techniques may include removing the object from the AI-generated background while keeping shadows and other effects in place, blurring portions of the AI-generated background where the object will be positioned, removing the outline from the object, and re-positioning the object in the AI-generated background with the outline removed.

### CROSS-REFERENCE TO RELATED APPLICATIONS

This application claims the benefit of the filing date of U.S. Provisional Application No. 63/468,132, filed May 22, 2023, the disclosure of which is hereby incorporated herein by reference.

### BACKGROUND

Generating imagery for digital content can be time consuming and expensive. For example, to achieve an aesthetic depiction of an object, such as a sneaker or a bottle of perfume, the object typically needs to be positioned and lighted against a background scene. The background scene may include, for example, an environment such as a basketball court, bathroom, flower garden, etc. Such environments can be difficult to scope out, reserve, and travel to. The background scene may also include components arranged in a setting, such as a bench to the left, a window, an arrangement of rolled towels, or any of a wide variety of other objects. If different background scenes are desired for different images, the time and effort required to capture imagery of the object in such backgrounds multiplies.

While some techniques for generating imagery utilize artificial intelligence (AI), such techniques can result in artifacts, such as erroneous depictions of elements. Examples of such artifacts may include distortion of the depicted object with respect to size, shape, coloring, lighting, etc. Other examples of artifacts may include misrepresentation of the object or background, such as by inclusion of unintended elements, omission of intended elements, etc. Such artifacts often render the generated image unusable, thereby requiring multiple additional attempts to generate the imagery, each attempt consuming additional processing power and leading to user frustration.

### BRIEF SUMMARY

The present disclosure provides for using artificial intelligence (AI) to generate imagery for digital content, such as digital imagery portraying specific objects. The imagery may include a background scene that is generated in response to verbal or textual input. The imagery also includes the object, such as a product. An image of the object may be captured and pre-processed, such that it can be positioned within the AI-generated scenery without artifacts, such as becoming misshapen, disfigured, mis-sized, having extraneous markings, etc. The pre-processing may include upscaling the object in the original image, segmenting the object from its background in the captured image, adding an outline or border stroke to the object. The AI-generated image may be generated with the object having the border stroke. For example, the object may be inserted into the AI-generated background with the outline intact. The AI-generated image may be further improved using one or more post-processing techniques. Such post-processing techniques may include removing the object from the AI-generated background while keeping shadows and other effects in place, blurring portions of the AI-generated background where the object will be positioned, removing the outline from the object, and re-positioning the object in the AI-generated background with the outline removed. According to some examples, the object may be slightly downsized as a further post-processing technique. Other post-processing techniques may include, for example, eroding pixels from the object border and blurring or feathering the border to better blend with the AI-generated background.

### BRIEF DESCRIPTION OF THE DRAWINGS

FIG. 1A illustrates an example captured image of an object, according to aspects of the disclosure.

FIGS. 1B-1D illustrate examples of the object of FIG. 1A in AI-generated images, according to aspects of the disclosure.

FIGS. 1E-1F illustrate an example interface for receiving input and generating the AI-generated images as output, according to aspects of the disclosure.

FIG. 2A illustrates an example captured image of an object.

FIG. 2B illustrates an example of pre-processing techniques applied to the object of FIG. 2A according to aspects of the disclosure.

FIG. 2C illustrates the object of FIG. 2B in an example AI-generated image according to aspects of the disclosure.

FIGS. 3A-B illustrate an example of post-processing the example AI-generated image of FIG. 2C according to aspects of the disclosure.

FIG. 4 illustrates an end-to-end example of generating an AI background for an object using masks according to aspects of the disclosure.

FIG. 5 illustrates an example of generating a foreground image according to aspects of the disclosure.

FIGS. 6A-F illustrates an example of post-processing for detection of whether the object in the AI-generated image appears to be floating, according to aspects of the disclosure.

FIG. 7 is a block diagram illustrating an example system according to aspects of the disclosure.

FIG. 8 is a block diagram illustrating an example computing environment according to aspects of the disclosure.

FIG. 9 is a block diagram illustrating an example artificial intelligence model architecture according to aspects of the disclosure.

FIG. 10 is a flow diagram illustrating an example method of generating images using artificial intelligence according to aspects of the disclosure.

FIG. 11 is a flow diagram illustrating an example method of post-processing for images generated using artificial intelligence according to aspects of the disclosure.

### DETAILED DESCRIPTION

The present disclosure provides for using portions of a captured image to create digital content using artificial intelligence (AI), wherein the resulting digital content includes the portions of the captured image without artifacts. For example, the captured image may depict an object having a plain or any other background. The object can be extracted from the captured image and placed within a digital image having scenery generated based on user input, such as text or verbal cues. For example, the user can enter an input such as “generate an image depicting the object resting on the deck of a yacht” and an image generation engine will extract the object from the captured image and place it within an AI-generated background depicting the requested yacht.

In some implementations, the techniques disclosed herein enable artificial intelligence to generate digital content using portions, such as objects or background elements, from captured images. AI is a segment of computer science that focuses on the creation of models that can perform tasks with little to no human intervention. Artificial intelligence systems can utilize, for example, machine learning, natural language processing, and computer vision. Machine learning, and its subsets, such as deep learning. focus on developing models that can infer outputs from data. The outputs can include, for example. predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts, etc.) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

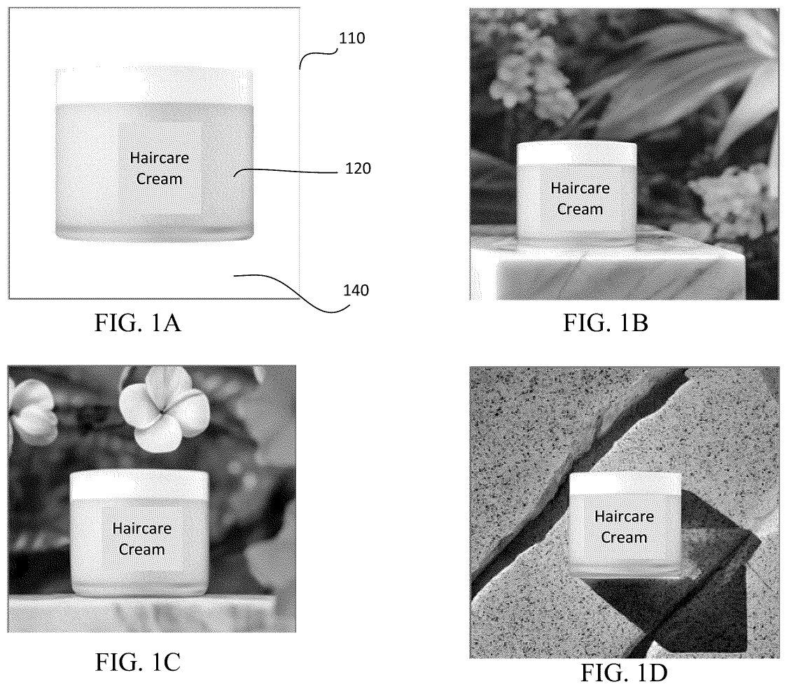

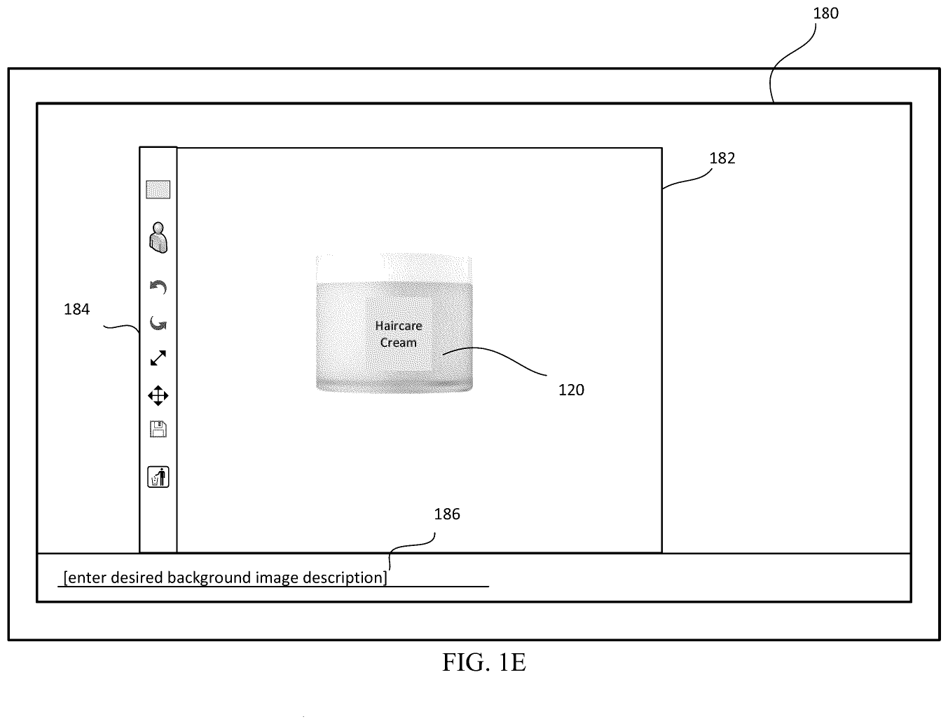

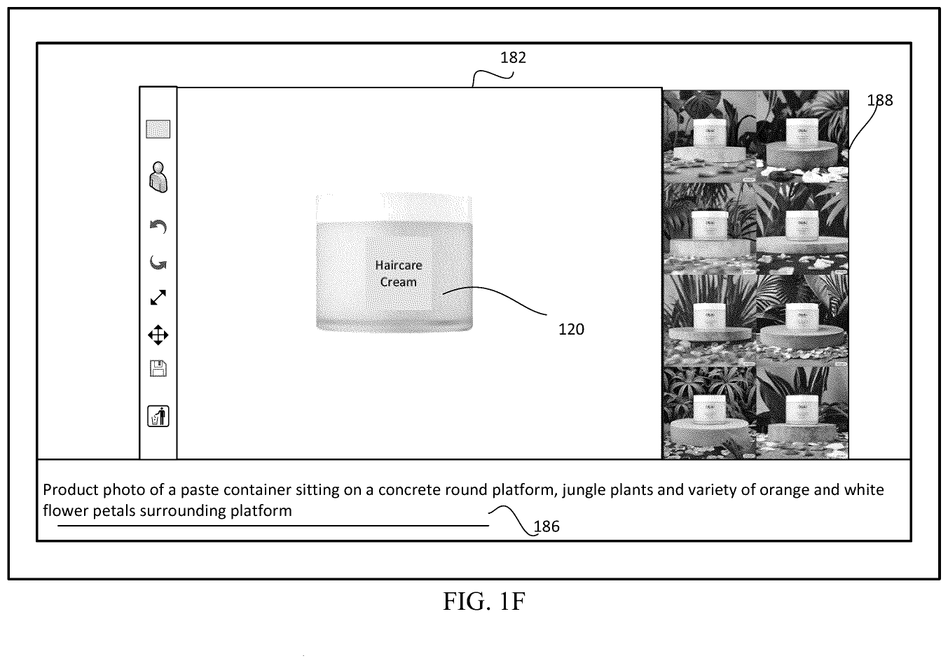

FIG. 1A illustrates an example image 110 of an object 120 to be used in AI-generated digital content. The object 120 may have any of various shapes, sizes, colors, etc. The example image 110 may capture the object 120 with any background 140, with the object 120 being in the foreground. In generating the digital content, the foreground including the object 120 is separated from the background 140 of the example image 110 originally capturing the object 120. The object 120 may then be placed in an AI-generated background image, such as shown in FIGS. 1B-1D. The AI-generated backgrounds of such images may be generated in response to text, verbal, or other cues specifying how the background should appear.

FIGS. 1B-1D illustrate various images generated using artificial intelligence, wherein the images provide different setting for the object 120. For example, FIG. 1B depicts the object 120 on a marble ledge with a botanical background including green leaves and orange flowers. FIG. 1C also depicts the object 120 on a marble ledge with a botanical background, but has a different perspective giving the appearance of being captured from a different camera angle than FIG. 1B. Moreover, FIG. 1C features different flowers, and blurs the green leaves in the background. FIG. 1D depicts the object 120 on a stone flowing with light from a top left portion casting a shadow on the lower right portion. Each of the images of FIGS. 1B-1D may be generated by an artificial intelligence model in response to receiving input in the form of text or verbal cues. For example, the text or verbal input for FIG. 1B may be “object on a marble ledge with green leaves and orange flowers behind it.”

FIG. 1E illustrates an example interface 180 for generating the digital content. In this example, the interface 180 includes a canvas 182 for the digital content, a toolbar 184, and an input field 186 for entering input dictating how the AI-generated content should appear. The object 120 is separated from its original background in the originally captured image and positioned on the canvas 182. The interface 180 may allow for input adjusting a position of the object 120 on the canvas 182, such as by moving the object 120 in any direction, resizing the object 120, etc. The adjusted position in the canvas 182 corresponds to how the object 120 will be sized and positioned in the AI-generated output. Such input may be entered by, for example, tools in the toolbar 184, click-and-drag operations using a cursor, voice commands, or any other input mechanism. Input field 184 may include a prompt requesting that the user enter a desired image description. The image description entered in the input field 184 may be used to generate the AI-generated background for the object 120.

FIG. 1F illustrates an example including output 188 generated through the interface 180. As shown, text entered in the input field 186 requests “product photo of a paste container sitting on a concrete round platform, jungle plants and variety of orange and white flower petals surrounding platform.” In response, a plurality of output images 188 are generated, each with a varying depiction that matches the entered text. In this regard, the user may select which image to use, or may enter another input in the input field 186 modifying the request. While in this example eight output options are provided, in other examples the interface 180 may generate a different number of outputs, such as one, three, twenty, or any other number.

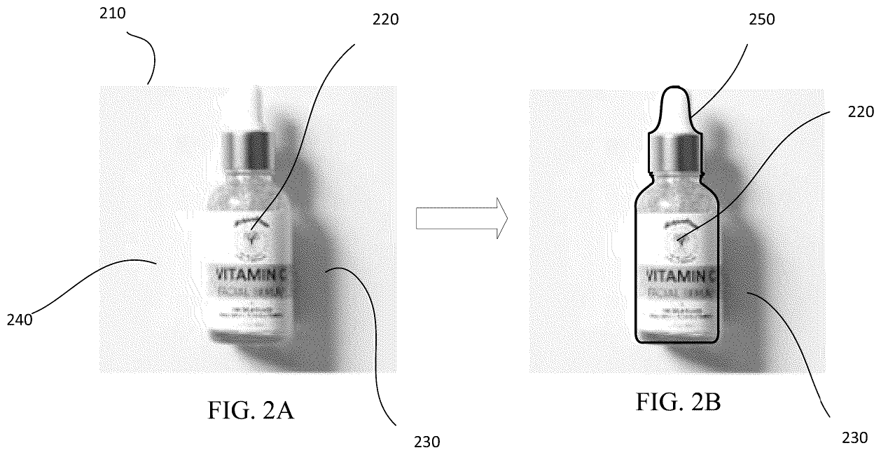

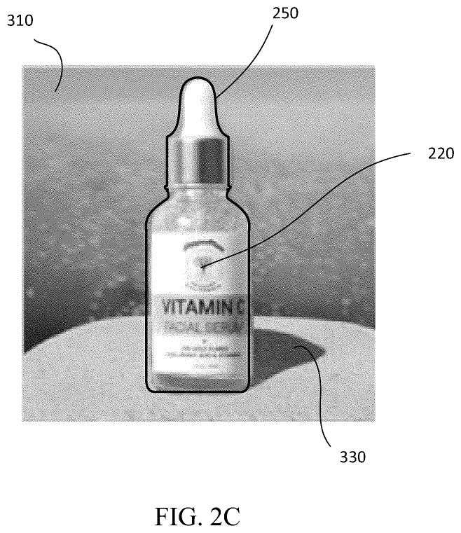

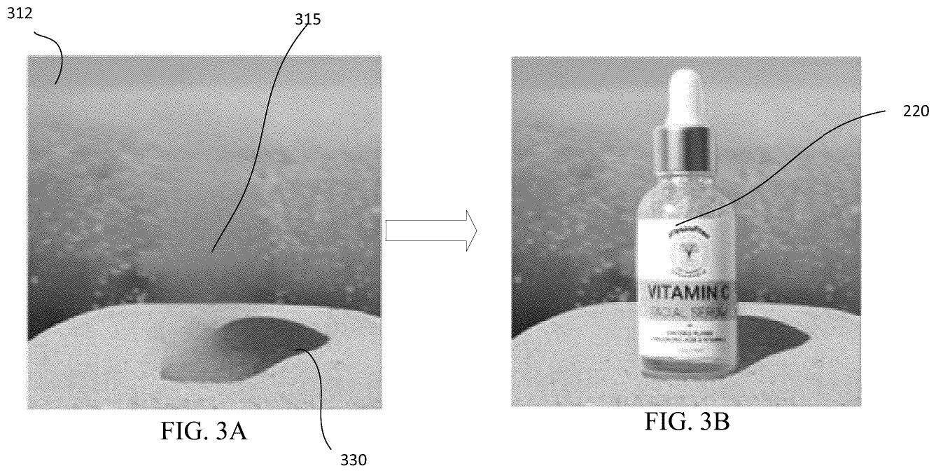

FIG. 2A illustrates an example captured image 210 of an object 220. The object 220 may be a product, such as a bottle, jar, box, etc. having a defined color, shape, label, etc. The captured image 210 may have any background 240, such as a plain or solid background. In this example, the background 240 is similarly colored to portions of the object 220. For example, the white cap and label can be difficult to distinguish from the white background 240. The captured image 210 may also include effects, such as lighting effects, shadows, etc. In this example, the captured image 210 includes a shadow 230 cast by lighting against the object 220. When generating AI images, the background 240 or effects such as shadow 230 in the original captured image 210 may cause artifacts in the AI-generated image. For example, they may cause the product in the AI-generated image to appear distorted or they may cause extraneous imagery to be included, such as halos, etc.

FIG. 2B illustrates an example of pre-processing techniques applied to the object of FIG. 2A. Such pre-processing techniques may help to mitigate the appearance of artifacts in the AI-generated image and/or to otherwise improve a quality of the AI-generated image. One example pre-processing technique is upscaling the object. Upscaling may include enlarging and/or improving a quality of the image. For example, this may include producing new pixels of image information to add detail filling in gaps, thereby generating a higher-resolution image.

Another example pre-processing technique includes separating a foreground of the captured image from the background. For example, the foreground including the object 220 may be separated from the background 240. Such separation may be performed using segmentation. Segmentation may be performed using machine learning techniques, such as classification of pixels as foreground pixels or background pixels based on color or other parameters. As another example, segmentation may be performed using a gradient-based algorithm, where region labels are spread outwards from seed points and stop at object boundaries. Edges may be detected by changes in luminance. Shadow 230 may be considered part of the background 240. Accordingly, when separating the foreground from the background, the shadow 230 may be eliminated.

Another example pre-processing technique includes adding a border stroke 250, or outline. to the object 220. In some examples, the border stroke 250 may be added manually by a user, such as by tracing an outline of the object 220 displayed on a touchscreen or by using another input device. According to some examples, the border stroke 250 may be added automatically. For example, where the separation of the foreground from the background 240 includes edge detection, one or more processors executing the edge detection algorithm can be further programmed to add the border-stroke 250 to the detected edges. For example, pragmatic image manipulation libraries may be used to apply the effects. The border may be a positive border applied from the edge outwards, or negative border applied from the edge of the image inwards. Where the border stroke 250 is added automatically, user input may be received to manually adjust or update the border stroke 250. In this regard, the outline can be adjusted to closely and accurately correspond to edges of the object 220.

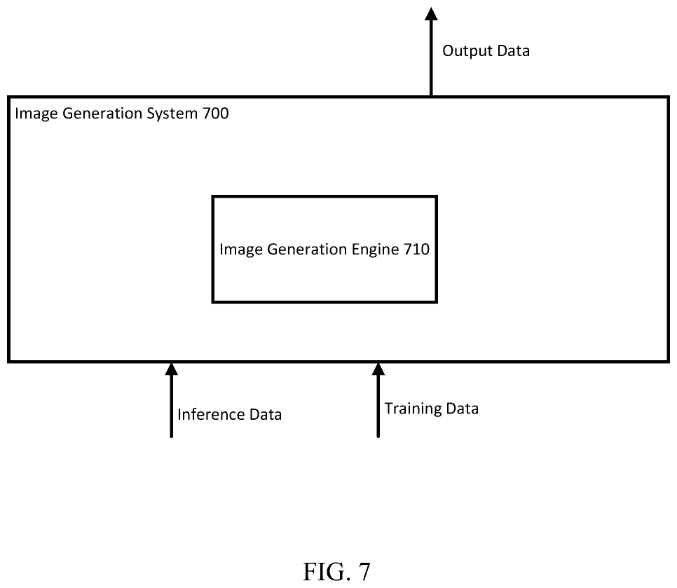

FIG. 2C illustrates the object 220 in an example AI-generated image 310. The object 220 includes border stroke 250. The AI-generated image 310 may be generated based on textual or verbal input cues. For example, an input command in a user interface may instruct to “display the product on a white rock in front of a field of yellow wildflowers.” The object 220 may be resized based on the input and the resulting output, such that it fits within the generated scene. According to some examples, effects such as AI-generated shadow 330 may be included in the AI-generated image 310. The effects may vary based on the input and output. The model used to generate the image 310 may be any of a variety of AI model, as discussed in further detail below in connection with FIGS. 7-9. The border-stroke 250 may remain in the AI-generated image as initially generated. The border-stroke 250 may help to reduce artifacts in the AI-generated image by establishing a clear boundary of the object.

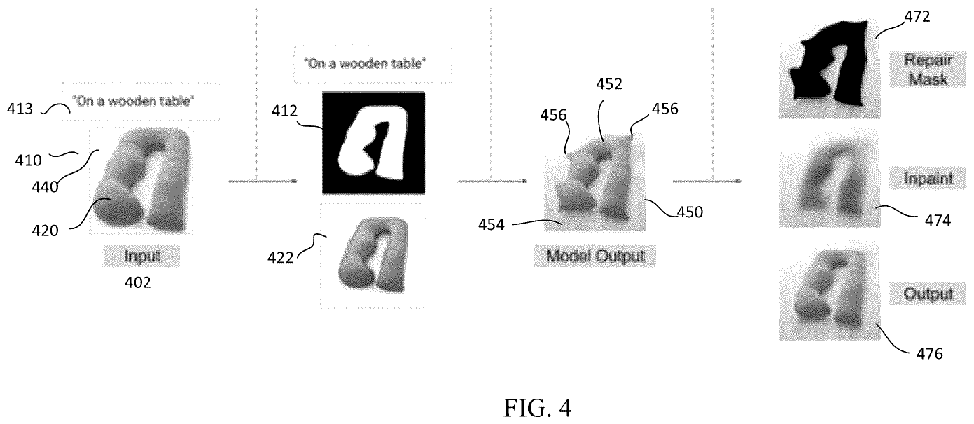

FIGS. 3A-B illustrate some examples of post-processing the AI-generated image 310. Post-processing may include applying treatments to the image 310 to improve an appearance of the image.

In FIG. 3A, the object 220 has been removed from the image 310, while keeping shadow 330 and other effects in place. This may be performed using image editing techniques such as large mask inpainting with fourier convolutions.

Once the object 220 has been removed, resulting image 312 can be retouched. For example, an area 315 in the image corresponding to where the object 220 was placed can be edited. Such editing can include, for example, blurring, clarifying, darkening, lightening, or otherwise modifying pixels in the area 315. In other examples, pixels in other areas of the image 310 can be edited, whether the object 220 was removed or not.

In FIG. 3B, the object 220 is re-inserted into the resulting image 312 that has been retouched. The border stroke 250 may be removed from the object 220 before or after re-insertion into the resulting image 312. In some examples, the object 220 may also be slightly downsized, such as to add padding around it. Other post-processing techniques may include, for example, eroding pixels from the object border and blurring or feathering the border to better blend with the AI-generated background.

While the examples illustrated in FIGS. 2-3 include application of a border stroke to the object of the original image and later removing the border stroke, in other examples additional or alternative pre-processing techniques and/or post-processing techniques may be utilized. For example, the border stroke may be omitted. Other pre-processing techniques may include resizing the object, such as by enlarging the object. Further example pre-processing techniques may include enhancing a resolution of the object, applying a mask to the original image including the object, etc. Example post-processing techniques may include downsizing objects, blurring or feathering of an area behind the object, etc. Further example post-processing techniques may include detection of a floating point for objects and adjusting for same.

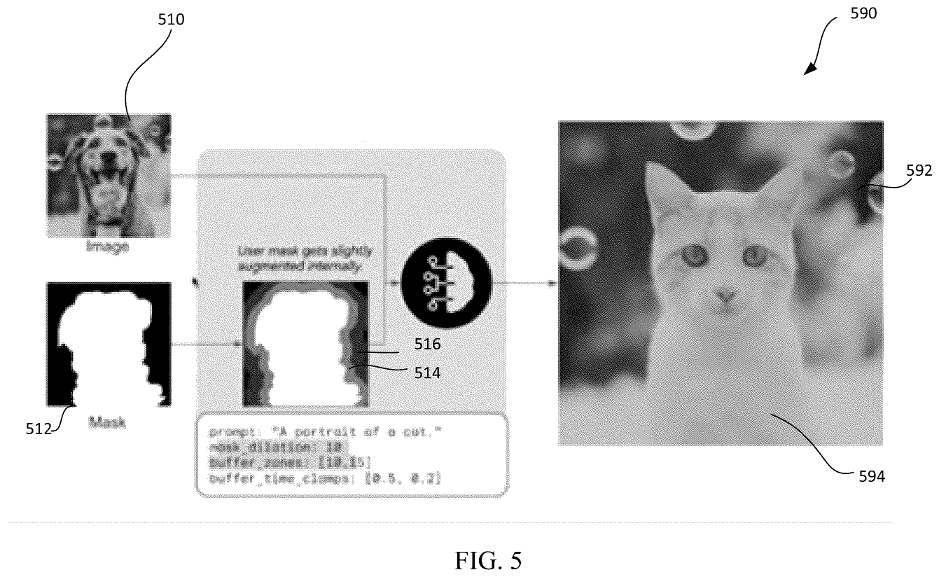

FIG. 4 illustrates an end-to-end example of generating an AI background for an object from an original image using masks.

Input 402 is received at a first model, the input 402 including a captured image 410 of an object 420 with a captured background 440. The input 402 further includes instructions 413 for generating the AI background. In this example, the instructions 413 indicate that the object 420 should be shown “on a wooden table” in the AI-generated image.

A first AI model applies a mask 412 to the captured image 410. The mask indicates an outline for the object 420. The mask 412 is used to separate the object 420 from the captured background 440, resulting in a foreground image 422 of only the object 420 without the captured background 440.

The first model, or a second model separate from the first model, uses the foreground image 422 and the input instructions 413 to generate initial model output 450. The initial model output 450 shows the object 452 on a wooden table 454. As seen in this example, the initial model output 450 includes artifacts 456. The artifacts 456 in this example include a distortion of the shape of the object. adding pointed flaps to the object.

A third model may be used for post-processing to correct the artifacts in the initial model output 450. The third model may be separate from either or both of the first and second models, or it may be part of the same model. In this example, the third model applies a repair mask 472 to the initial model output 450. The repair mask 472 isolates the object having the artifacts, such that the object with the artifacts can be removed from the model output. The repair mask may be applied automatically, such that it automatically detects an outline of the object 452 from the model output 450. Such automatic detection may be based on differentiation of pixels by color or shade. In this regard, the model output 450 may be repaired regardless of how the artifacts alter the object 420.

Once the object with the artifacts is removed, further post-processing may include inpainting 474. Inpainting may include, for example, blurring, feathering, erosion, or other image editing techniques to blend remnants of the object after applying the repair mask with the AI-generated background.

In a final output 476, the foreground image 422 of only the object 420 is pasted onto the inpainted AI-generated background. By automatically repairing the model output 450 in the post-processing stage, the system produces a quality image. Artifacts are detected and removed by the repair mask and retouching, regardless of how the artifacts manifest in the initial model output 450. Because the solution is agnostic to where the artifacts appear in the model output 450, it avoids errors that may otherwise be encountered in attempting to correct the output. Therefore this solution utilizes reduced processing power and processing time over solutions that would require identifying artifacts precisely to execute corrections at the locations of the artifacts.

While the examples illustrated in FIGS. 2-4 include placement of a foreground object from a captured image in an AI-generated background, other examples may include placement of an AI-generated foreground object in a captured image background.

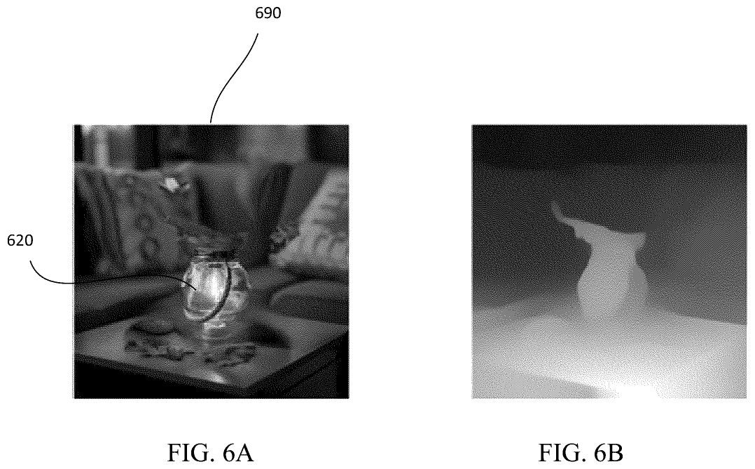

FIG. 5 illustrates an example of pre-processing techniques including applying a mask to an originally captured image, and augmenting the mask with a buffer zone. FIG. 5 further illustrates generating a foreground object using AI, and placing the AI-generated foreground image on a background of a captured image. In this examples, original captured image 510 depicts a dog in the foreground with bubbles and greenery in the background. A mask 512 is applied to the image 510, wherein the mask defines which pixels belong to the foreground and which belong to the background. The mask can be applied manually or automatically, such as using an artificial intelligence model.

In some examples, the mask 512 may be augmented to create one or more buffer zones 514, 516. Augmenting the mask 512 may include expanding an outline defined by the mask 512. In this example, first buffer zone 514 expands the mask 512 by a first amount, and second buffer zone 516 expands the mask 512 by a second amount that is greater than the first amount. According to some examples, the amount of expansion of each buffer zone 514, 516 may be defined by a user. In other examples, it may be a default amount, or an automatic amount based on features within the mask, such as a relative size of the foreground object in comparison to the background, a shape of the mask, an amount of variation between different portions of the mask, etc.

Based on the augmented mask, the foreground can be separated from the background. Augmenting the mask can ensure that all pixels belonging to the foreground object are included in the separation of the foreground from the background. To prevent an obvious outline around the object separated from the foreground, pixels and colors in the augmented portion of the mask can be averaged.

In the present example, input requests that the foreground object of the original image 510 be changed, specifically from a dog to a cat. Accordingly, output image 590 is generated, which includes a background 592 from the original image 510 but replaces the dog with a cat as the foreground object 594.

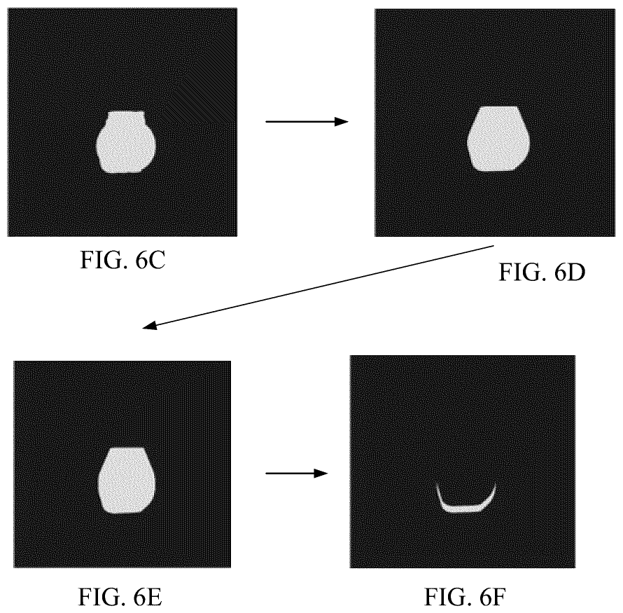

FIGS. 6A-6E illustrate an example of a post-processing technique including detection of whether the object depicted in the AI-generated background appears to be floating. FIG. 6A depicts an AI-generated image 690 including an object 620, which may have been captured in an original image using an image-capture device such as a camera. Determining whether the object 620 appears to be floating can be performed automatically, with generation of a depth map and computations based on the depth map, wherein a result of the computations indicates whether or not the object 620 is floating. Based on the results, the object 620 can be moved within the AI-generated background. For example, if the results indicate that the object 620 appears to be floating, the object can be moved manually or automatically.

FIG. 6B illustrates an example of the depth map. The depth map may be generated using the image 690. For example, the depth map may be generated using an artificial intelligence model.

FIG. 6C illustrates an object mask, generated based on the depth map. FIG. 6D illustrates a convex hull of the object mask. An integral of the mask is calculated, while vertically displacing the object mask downward. For example, the object mask may be vertically displaced by a number of pixels, by a distance relative to a size of the object mask, by a distance relative to a position of the mask with respect to a lower border of the mask, etc. FIG. 6E illustrates an integral shifting down of the convex hull mask. To calculate a surface region beneath the object, the integral of the downward shift of the convex hull mask is subtracted from the convex hull mask, as shown in FIG. 6F. The depth for the object mask and the depth of the surface area are computed, for example, using an AI model. The depth displacement of the surface underneath the object is computed, along with its normalized value. For an object at rest on a surface, the computed depth displacement should be approximately zero. However, results within a predetermined range above or below zero may also correspond to satisfactory placement of the object within the AI-generated image. For results outside of the predetermined range, the object may be moved. For example, the object can be shifted down by one or more pixels in the background, and an absolute depth difference between the object and the surface is computed. This process can be repeated a number of times. From those computations, a location with the minimum absolute depth difference may be identified as the surface on which the object should be placed.

FIG. 7 depicts a block diagram of an example image generation system, which can be implemented on one or more computing devices. The image generation system can be configured to receive inference data and/or training data for use in generating images for content. For example, the image generation system can receive the inference data and/or training data as part of a call to an application programming interface (API) exposing the image generation system to one or more computing devices. Inference data and/or training data can also be provided to the image generation system through a storage medium, such as remote storage connected to the one or more computing devices over a network. Inference data and/or training data can further be provided as input through a user interface on a client computing device coupled to the image generation system.

The inference data can include data associated with verbal or textual input commands to generate an image using the image generation engine 710. For example, inference data can be keywords or phrases describing scenery, such as “a baseball field at night.”

The training data can correspond to an artificial intelligence (AI) or machine learning task for generating images based on textual or verbal input cues, such as a task performed by a neural network. The training data can be split into a training set, a validation set, and/or a testing set. An example training/validation/testing split can be an 80/10/10 split, although any other split may be possible. The training data can include, for example, sample images and associated keywords or phrases.

The training data can be in any form suitable for training a model, according to one of a variety of different learning techniques. Learning techniques for training a model can include supervised learning, unsupervised learning, and semi-supervised learning techniques. For example, the training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

From the inference data and/or training data, the image generation system can be configured to output one or more results related to images generated as output data. As examples, the results can be any kind of score, classification, or regression output based on the input data.

As an example, the image generation system can be configured to send output data for display on a client or user display. As another example, the image generation system can be configured to provide the output data as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The image generation system can further be configured to forward the output data to one or more other devices configured for translating the output data into an executable program written in a computer programming language. The image generation system can also be configured to send the output data to a storage device for storage and later retrieval.

The image generation system 700 can include one or more image generation engines 710. The image generation engines 710 can be engines, models, or modules implemented as one or more computer programs, specially configured electronic circuitry, or any combination thereof. The image generation engines 710 can be configured to generate imagery in response to verbal or textual input.

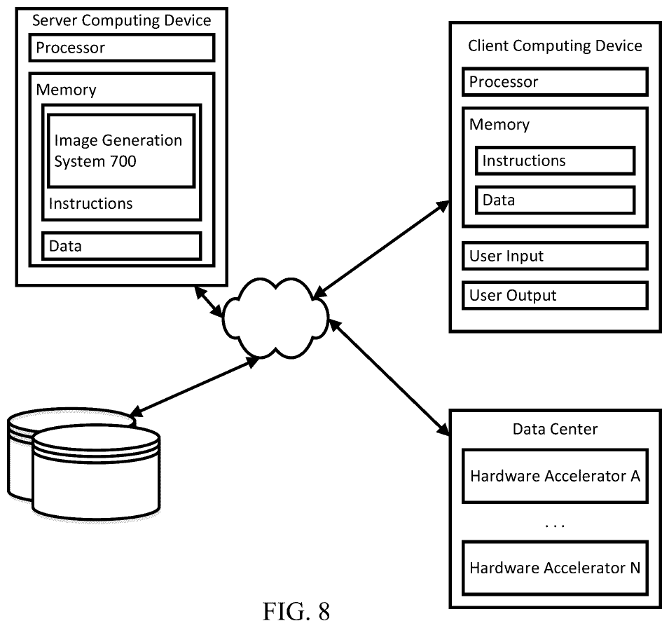

FIG. 8 depicts a block diagram of an example environment for implementing an image generation system 700. The image generation system 700 can be implemented on one or more devices having one or more processors in one or more locations, such as in server computing device. Client computing device and the server computing device can be communicatively coupled to one or more storage devices over a network. The storage devices can be a combination of volatile and non-volatile memory and can be at the same or different physical locations than the computing devices. For example, the storage devices can include any type of non-transitory computer readable medium capable of storing information, such as a hard-drive, solid state drive, tape drive, optical storage, memory card, ROM, RAM, DVD, CD-ROM, write-capable, and read-only memories.

The server computing device can include one or more processors and memory. The memory can store information accessible by the processors, including instructions that can be executed by the processors. The memory can also include data that can be retrieved, manipulated, or stored by the processors. The memory can be a type of non-transitory computer readable medium capable of storing information accessible by the processors, such as volatile and non-volatile memory. The processors can include one or more central processing units (CPUs), graphic processing units (GPUs), field-programmable gate arrays (FPGAs), and/or application-specific integrated circuits (ASICs), such as tensor processing units (TPUs).

The instructions can include one or more instructions that, when executed by the processors, cause the one or more processors to perform actions defined by the instructions. The instructions can be stored in object code format for direct processing by the processors, or in other formats including interpretable scripts or collections of independent source code modules that are interpreted on demand or compiled in advance. The instructions can include instructions for implementing the image generation system 700. The image generation system can be executed using the processors, and/or using other processors remotely located from the server computing device.

The data can be retrieved, stored, or modified by the processors in accordance with the instructions. The data can be stored in computer registers, in a relational or non-relational database as a table having a plurality of different fields and records, or as JSON, YAML, proto, or XML documents. The data can also be formatted in a computer-readable format such as, but not limited to, binary values, ASCII, or Unicode. Moreover, the data can include information sufficient to identify relevant information, such as numbers, descriptive text, proprietary codes, pointers, references to data stored in other memories, including other network locations, or information that is used by a function to calculate relevant data.

The client computing device can also be configured similarly to the server computing device, with one or more processors, memory, instructions, and data. The client computing device can also include a user input and a user output. The user input can include any appropriate mechanism or technique for receiving input from a user, such as keyboard, mouse, mechanical actuators, soft actuators, touchscreens, microphones, and sensors.

The server computing device can be configured to transmit data to the client computing device, and the client computing device can be configured to display at least a portion of the received data on a display implemented as part of the user output. The user output can also be used for displaying an interface between the client computing device and the server computing device. The user output can alternatively or additionally include one or more speakers, transducers or other audio outputs, a haptic interface or other tactile feedback that provides non-visual and non-audible information to the platform user of the client computing device.

Although FIG. 8 illustrates the processors and the memories as being within the computing devices, components described herein can include multiple processors and memories that can operate in different physical locations and not within the same computing device. For example, some of the instructions and the data can be stored on a removable SD card and others within a read-only computer chip. Some or all of the instructions and data can be stored in a location physically remote from, yet still accessible by, the processors. Similarly, the processors can include a collection of processors that can perform concurrent and/or sequential operation. The computing devices can each include one or more internal clocks providing timing information, which can be used for time measurement for operations and programs run by the computing devices.

The server computing device can be connected over the network to a data center housing any number of hardware accelerators. The data center can be one of multiple data centers or other facilities in which various types of computing devices, such as hardware accelerators, are located. Computing resources housed in the data center can be specified for deploying models related to generating images based on text or verbal input cues as described herein.

The server computing device can be configured to receive requests to process data from the client computing device on computing resources in the data center. For example, the environment can be part of a computing platform configured to provide a variety of services to users, through various user interfaces and/or application programming interfaces (APIs) exposing the platform services. The variety of services can include generating images based on text or verbal input cues. The client computing device can transmit input data, such as the textual or verbal input cues. The image generation system can receive the input data, and in response, generate output data including an image including an object, such as a product with background imagery corresponding to the textual or verbal input cues.

As other examples of potential services provided by a platform implementing the environment, the server computing device can maintain a variety of models in accordance with different constraints available at the data center. For example, the server computing device can maintain different families for deploying models on various types of TPUs and/or GPUs housed in the data center or otherwise available for processing.

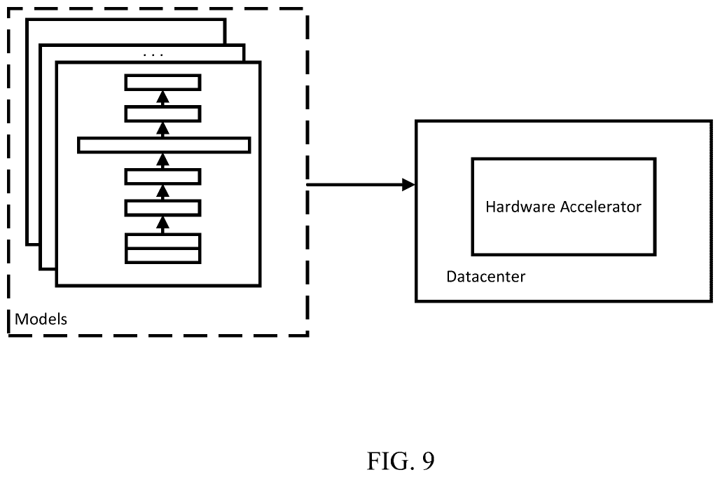

FIG. 9 depicts a block diagram illustrating one or more model architectures, such as for deployment in a data center housing a hardware accelerator on which the deployed models will execute for generating images based on textual or verbal input cues. The hardware accelerator can be any type of processor, such as a CPU, GPU, FPGA, or ASIC such as a TPU.

An architecture of a model can refer to characteristics defining the model, such as characteristics of layers for the model, how the layers process input, or how the layers interact with one another. For example, the model can be a convolutional neural network (ConvNet) that includes a convolution layer that receives input data, followed by a pooling layer, followed by a fully connected layer that generates a result. The architecture of the model can also define types of operations performed within each layer. For example, the architecture of a ConvNet may define that rectified linear unit (ReLU) activation functions are used in the fully connected layer of the network. One or more model architectures can be generated that can output results such as images corresponding to the textual or verbal input cues.

Referring back to FIG. 8, the devices and the data center can be capable of direct and indirect communication over the network. For example, using a network socket, the client computing device can connect to a service operating in the data center through an Internet protocol. The devices can set up listening sockets that may accept an initiating connection for sending and receiving information. The network itself can include various configurations and protocols including the Internet, World Wide Web, intranets, virtual private networks, wide area networks, local networks, and private networks using communication protocols proprietary to one or more companies. The network can support a variety of short-and long-range connections. The short-and long-range connections may be made over different bandwidths, such as 2.402 GHz to 2.480 GHz, commonly associated with the Bluetooth® standard, 2.4 GHZ and 5 GHz, commonly associated with the Wi-Fi® communication protocol; or with a variety of communication standards, such as the LTER standard for wireless broadband communication. The network, in addition or alternatively, can also support wired connections between the devices and the data center, including over various types of Ethernet connection.

Although a single server computing device, client computing device, and data center arc shown in FIG. 8, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

In addition to the foregoing systems, various methods will now be described. While the methods include operations described in a particular order, it should be understood that operations can be performed in a different order or simultaneously. Moreover, operations may be added or omitted.

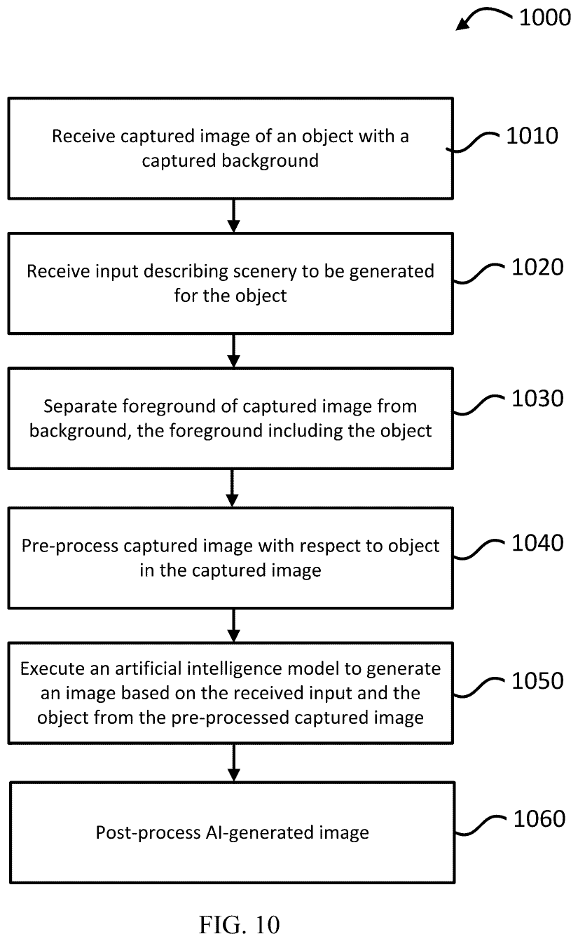

FIG. 10 is a flow diagram illustrating an example method 800 of generating images using artificial intelligence. The method 800 may be performed by one or more processors, such as in the computing environment described above.

In block 1010, a captured image is received, the captured image including an object and its background. The object can be any object, such as a product, person, animal, etc.

In block 1020, input is received describing scenery to be generated for the object. For example, the input may be user input in the form of text or verbal cues. In other examples, the input can be a selection, such as from a list of possible features for inclusion in the scenery.

In block 1030, a foreground of the captured image is separate from the background of the captured image. Such separation may be performed using segmentation or other techniques, such as shallow depth of field, contrasting colors, contrasting brightness, edge lighting, motion blur, layers, masks, etc. The separation may be performed manually or by an automated or machine learning process. As a result of the separation, the object depicted in the image is isolated from the background.

In block 1040, the captured foreground image including the object is pre-processed with respect to the object. Such pre-processing may include, for example, upscaling, adding a border stroke around the object, applying a mask, adding a buffer zone to the mask, etc. Upscaling may include increasing a resolution of the object by adding pixels to fill in gaps between pixels of a lower-resolution representation. In some examples, upscaling may also include enlarging the object. The border stroke may be an outline of the object. The border stroke may be added manually or automatically. For example, one or more processors can detect an edge of the object and automatically apply the border stroke at the detected edge. Applying a mask to the image can including identifying a shape or object within the captured image and masking the shape or object, or masking portions of the image that are outside of the shape or object.

Other post-processing techniques may include, for example, erosion of pixels. For example, pixels corresponding to artifacts or more generally pixels corresponding to any portion of the object represented in the initial model output may be removed. According to some examples, a shape of the object from the originally captured image may be compared to a shape of the object in the initial model output, and any portion of the object in the initial model output that extends beyond the shape of the object from the original image may be removed.

In block 1050, an artificial intelligence model is executed to generate an image based on textual or verbal cues, the generated image including the pre-processed object from the captured image. For example, a verbal or textual input can describe an environment or setting desired to be depicted in the AI-generated image. The pre-processed object can also be input. In response, an image generation engine generates an image that depicts the object in the setting or environment in accordance with the input. According to some examples, multiple images may be generated, each depicting a variation of the received input. In this regard, a user can select one or more of the multiple images.

In block 1060, post-processing of the AI-generated image is performed. Example post-processing operations may include re-touching the image, removing the border stroke from the object. downsizing the object, etc. For example, where the pre-processing includes applying a border stroke, the resulting image may depict the object still having the border stroke. The border stroke may create a clear boundary for the object and therefore reduce distortions or other artifacts that can otherwise occur. The post-processing can include removing the border stroke. In other examples, whether or not a border stroke is applied, post-processing can include retouching the AI-generated image. According to some examples. the object is removed from the AI-generated image, while leaving shadows and other effects intact. The AI-generated image is retouched, such as by blurring or feathering the AI-generated background at an area from which the object was previously positioned and removed. The object may be re-inserted in the AI-generated image at the area from which it was removed. In some examples, the object may be slightly downsized. In some examples, the post-processing may further include eroding pixels from the object border, and blurring or feathering the border to better blend with the AI-generated background.

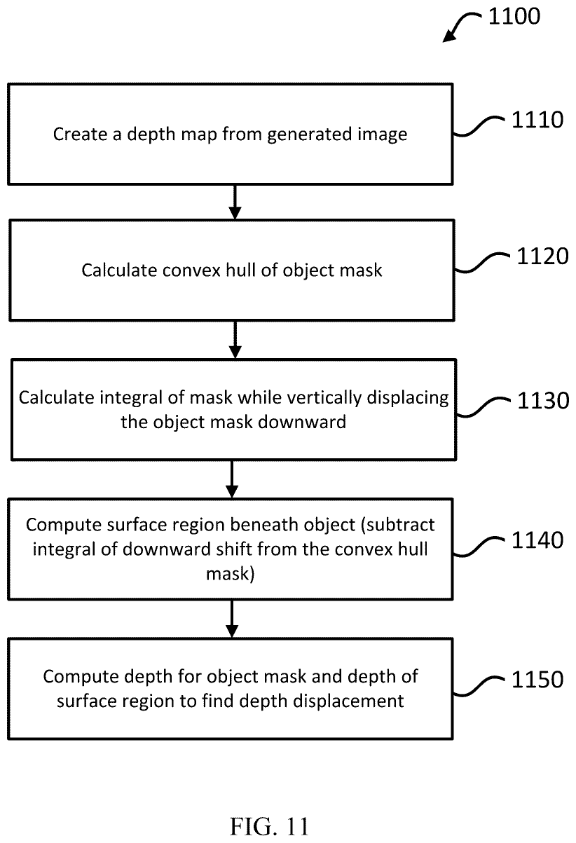

Another example post-processing technique includes detection of whether the object appears to be floating within the AI-generated background, or whether it appears to be resting on a surface. An example method 1100 of such floating object detection is described in connection with FIG. 11.

In block 1110, a depth map is created from the generated image, as illustrated in the example of FIG. 6B. In block 1120, an object mask is applied and a convex hull of the object mask is calculated. In block 1130, an integral of the mask is calculated while vertically displacing the object mask downward. For example, the downward placement can be by a predetermined number of pixels, a distance relative to a size of the object mask, a distance relative to the image or its borders, etc. In block 1140, a surface region beneath the object is computed. For example, the integral of the downward shift is subtracted from the convex hull mask. In block 1150 a depth for the object mask and a depth of the surface region beneath it is computed to find the depth displacement. Based on the resulting depth displacement. and/or a normalized value for the depth displacement, it can be inferred whether the object is floating. For example, if the normalized value of the depth displacement falls within a predetermined range, it can be inferred that the object is not floating.

Further example post-processing techniques can include erosion of the object pasted into the AI-generated background. For example, such erosion can include removing pixels around a border of the object, so as to improve a blending of the pasted object and the AI-generated background.

While the method above describes replacing a captured background from an image with an AI-generated background and placing the object from the captured image in the AI-generated background, similar techniques may be applied in placing an AI-generated object within a captured background from a captured image. For example, input can be received describing a foreground object to place within the captured background. The foreground can be separated from the background as described in block 1030, and the foreground can be replaced with an AI-generated image, such as the cat in FIG. 5. The pre-processing and post-processing techniques, such as masking and blurring, can be applied to reduce artifacts in the output image.

The disclosure herein is advantageous in that it provides an efficient process resulting in improved image quality. As a result of the process, images may be generated without spending the time and effort to travel to a destination, set the background, pose the product, etc.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of generating imagery, comprising:
receiving, with one or more processors, a captured image of an object and a captured background;
receiving text or verbal input specifying scenery to be generated for the object;
separating, with the one or more processors, a foreground of the captured image from the captured background, the foreground including the object;
generating, with the one or more processors based on the object, imagery in response to the received input, the imagery depicting the object and the scenery corresponding to the received text or verbal input; and
applying one or more post-processing techniques to the generated scenery, including removing the depicted object from the generated imagery, retouching the scenery of the imagery in an area corresponding to the object, and re-inserting the object from the captured image into the imagery.

2. The method of claim 1, wherein generating the imagery comprises executing an artificial intelligence model.

3. The method of claim 1, further comprising applying one or more pre-processing techniques to the object, including applying a border stroke to an outline of the object.

4. The method of claim 3, wherein applying the border stroke comprises automatically detecting, with the one or more processors, an edge of the object and applying the border stroke to the detected edge in response.

5. The method of claim 1, wherein removing the object from the imagery comprises applying a repair mask to the generated imagery.

6. The method of claim 1, wherein retouching the scenery of the imagery comprises blurring or feathering the imagery.

7. The method of claim 1, further comprising upscaling the object prior to generating the imagery.

8. The method of claim 7, further comprising downsizing the object upon placement in the generated imagery.

9. The method of claim 1, further comprising:
applying a mask to the captured image, the mask defining a shape of the object; and
augmenting the mask.

10. The method of claim 1, wherein the one or more post-processing techniques comprises detecting whether the object in the generated imagery appears to be floating, the detecting comprising:
generating a depth map for the object from the generated imagery;
generating an object mask from the depth map;
generating a convex hull of the object mask;
calculating an integral of the mask while vertically displacing the object mask downward;
computing a surface region beneath the object by subtracting the integral from the convex hull mask;
computing a depth for the object mask and a depth of the surface region; and
computing depth displacement based on the depth for the object mask and the depth of the surface region; and
determining whether a normalized value for the computed depth displacement falls within a predetermined range.

11. A system for generating imagery, comprising:
memory; and
one or more processors in communication with the memory, the one or more processors configured to:
receive a captured image of an object in a captured background;
receive text or verbal input specifying scenery to be generated for the object;
separate a foreground of the captured image from the captured background, the foreground including the object;
generate, based on the object, imagery in response to the received input, the imagery depicting the object and the scenery corresponding to the received textual or verbal cues; and
apply one or more post-processing techniques to the generated scenery, including removing the depicted object from the generated imagery, retouching the scenery of the imagery in an area corresponding to the object, and re-inserting the object from the captured image into the imagery.

12. The system of claim 11, wherein in generating the imagery the one or more processors are further configured to execute an artificial intelligence model.

13. The system of claim 11, wherein the one or more processors are further configured to apply one or more pre-processing techniques including applying a border stroke to an outline of the object.

14. The system of claim 13, wherein applying the border stroke comprises automatically detecting, with the one or more processors, an edge of the object and applying the border stroke to the detected edge in response.

15. The system of claim 11, wherein removing the object from the imagery comprises applying a repair mask to the generated imagery.

16. The system of claim 11, wherein the one or more processors are further configured to upscale the object prior to generating the imagery.

17. The system of claim 16, wherein the post-processing techniques comprise downsizing the object.

18. A non-transitory computer-readable medium storing instructions executable by one or more processors to perform a method of generating imagery, the method comprising:
receiving a captured image of an object and a captured background;
receiving text or verbal input specifying scenery to be generated for the object;
separating a foreground of the captured image from the captured background, the foreground including the object;
generating, based on the object, imagery in response the received input, the imagery depicting the object and the scenery corresponding to the received text or verbal input; and
applying one or more post-processing techniques to the generated scenery.

19. The non-transitory computer-readable medium of claim 18, wherein generating the imagery comprises executing an artificial intelligence model.

20. The non-transitory computer-readable medium of claim 17, wherein removing the object from the imagery comprises applying a repair mask to the generated imagery.
